(19) United States
(12) Patent Application Publication
(10) Pub. No.: US 2009/0180174 A1
(43) Pub. Date: Jul. 16, 2009

(54) RARE-EARTH-DOPED OPTICAL FIBER, OPTICAL FIBER AMPLIFIER, AND METHOD OF MANUFACTURING A PREFORM FOR SUCH FIBER

(75) Inventors: Tetsuya Haruna, Kanagawa (JP); Manabu Ishikawa, Yokohama-shi (JP)

Correspondence Address: MCDERMOTT WILL & EMERY LLP, 600 13TH STREET, N.W., WASHINGTON, DC, 20005-3096, US

(73) Assignee: SUMITOMO ELECTRIC INDUSTRIES, LTD.

(21) Appl. No.: 12/352,067

(22) Filed: Jan. 12, 2009

(30) Foreign Application Priority Data
Jan. 15, 2008 (JP) 2008-006074

(51) Int. Cl. H01S 3/091; C03B 37/01; G02B 6/02; H01S 3/14

(52) U.S. Cl. 359/341.3; 65/390; 385/123; 359/341.5

(57) ABSTRACT

A first step, in which P₂O₅-containing glass is deposited inside a silica glass pipe, and a second step, in which a Cl₂-containing gas is introduced into the pipe and the P₂O₅-containing glass is dehydrated by heating the pipe, are repeated alternately. A third step, in which glass that does not contain P₂O₅ is deposited on the inside of the silica glass pipe, may further be provided such that the first step, the second step, and the third step are repeatedly performed in this order. A rare-earth-doped optical fiber, which has a attenuation of 15 dB/km or less at a wavelength of 1200 nm, comprises a core region and a cladding region enclosing the core region, wherein the core region includes phosphorus of 3 wt % or more, aluminum of 0.3 wt % or more, a rare-earth element of 500 wtppm or more, and chlorine of 0.03 wt % or more, and the cladding region has a refractive index that is lower than the refractive index of the core region.

### BACKGROUND OF THE INVENTION

1. Field of the Invention

The present invention relates to an optical fiber having a core region in which a rare-earth element is doped, an optical fiber amplifier which performs optical amplification using such an optical fiber, and a method of producing a preform that is suitable for making such an optical fiber.

2. Description of the Background Art

A rare-earth-doped optical fiber is an optical fiber having a core region in which a rare-earth element (e.g., erbium) is doped, and it is used as a medium for optical amplification in an optical fiber amplifier. The rare-earth-doped optical fiber is manufactured, in a similar manner as an optical fiber for transmission, by drawing a preform while heating it sequentially from its one end toward the other end.

One method for manufacturing a preform is a modified chemical vapor deposition method (MCVD method). In the MCVD method, first a glass particle deposited layer is formed by introducing a raw material gas inside a silica glass pipe and heating the silica glass pipe and by depositing the fine glass particles formed from the raw material gas on the inner wall of the silica glass pipe. Next, the glass particle deposited layer is further heated under an atmosphere of halogen gas such as chlorine gas so that it may be processed to a consolidated glass layer by dehydrating and consolidating it. Methods of manufacturing a preform for a rare-earth-doped optical fiber by the MCVD method are disclosed in Japanese Patent Application Publication Nos. H5-330842 (Document 1), H6-298542 (Document 2), H7-069666 (Document 3), H9-025135 (Document 4). In these preform manufacturing methods, the deposition process and the dehydration process are separately performed.

In the preform manufacturing methods disclosed in Documents 1 to 3, an impregnation process for impregnating glass-particle-deposited layers with a solution that contains a chloride of rare-earth element is provided between the deposition process and the dehydration process. In the preform manufactured in this way, the part produced by deposition, impregnation, dehydration, and consolidation according to the MCVD method becomes a core region, and the silica glass pipe becomes a cladding region. In such method, in order to adjust the impregnation quantity in the impregnation process, the thickness of glass (i.e., glass-particle-deposited layers) is limited to a certain thickness; therefore, the size of a preform that can be manufactured is limited accordingly, which results in extremely low productivity.

On the other hand, in the preform manufacturing method disclosed in Document 4, first, a glass particle deposited layer that includes a rare-earth element is formed on the inner wall of a silica glass pipe by supplying the rare-earth element in a gaseous state; next, under an atmosphere of halogen gas such as chlorine gas, the glass particle deposited layer is processed into a consolidated glass layer by dehydration and sintering by means of heating. This method is rather good in terms of productivity but has a shortcoming in that if a preform made by the method is doped with high concentration of phosphorus in the core region, the optical fiber made therefrom suffers from increase in the attenuation. The heating temperature for consolidating a glass layer doped with phosphorus is 1100 to 1200° C. with respect to the surface temperature of the silica glass pipe, and for both the deposition process and the dehydration process, the heating temperature must be lower than the heating temperature for the above-mentioned consolidating process. Therefore, in the deposition process, the oxidation reaction of the organic raw material gas that includes a rare-earth element does not sufficiently progress and accordingly the rare-earth element will not be incorporated into the glass particle deposited layer. Also, the dehydration and the removal of impurities will not sufficiently be achieved.

### SUMMARY OF THE INVENTION

The object of the present invention is to provide a method of producing a preform for efficiently making a low-loss optical fiber that is doped with phosphorus and a rare-earth element, and to provide an optical fiber made from the preform prepared by the method, as well as an optical fiber amplifier capable of optical amplification in a broad bandwidth by using the optical fiber.

In order to achieve the object, a preform manufacturing method is provided, in which a first step and a second step are alternately repeated: the first step is such that P₂O₅-containing glass is deposited on the inside of a silica glass pipe; and the second step is such that Cl₂-containing gas is introduced inside the silica glass pipe and the P₂O₅-containing glass is dehydrated by heating the silica glass pipe. In this case, in the first step, the P₂O₅-containing glass may be deposited on the inner wall of the silica glass while a heat source traverses a plurality of times along the silica glass pipe. Also, in the second step, while the heat source traverses a plurality of times along the silica glass pipe, the Cl₂-containing gas may be introduced inside the silica glass pipe and the dehydration may be done. Also, a third step may be provided such that while the heat source traverses one or plurality of times along the silica glass pipe, glass which does not include P₂O₅ is deposited on the inside of the silica glass pipe, and the first step, the second step, and the third step may be repeatedly performed in this order.

In addition, the invention provides a rare-earth-doped optical fiber which has a attenuation of 15 dB/km or less at a wavelength of 1200 nm and which comprises a core region and a cladding region enclosing the core region, where the core region includes phosphorus of 3 wt % or more, aluminum of 0.3 wt % or more, rare-earth of 500 wtppm or more, and chlorine of 0.03 wt % or more, and the cladding region has a refractive index that is lower than the refractive index of the core region.

Moreover, the present invention provides an optical fiber amplifier comprising a rare-earth-doped optical fiber of the present invention, a pump light source for outputting pump light with a wavelength capable of exciting the rare-earth element that is added to the core region of the rare-earth-doped optical fiber, and a multiplexer/demultiplexer for supplying the pump light, which is output from the pump light source, to the rare-earth-doped optical fiber.

### BRIEF DESCRIPTION OF THE DRAWINGS

These and other features, aspects, and advantages of the present invention will be better understood through the following description, appended claims, and accompanying drawings. In the explanation of the drawings, an identical mark is applied to identical elements and an overlapping explanation will be omitted.

FIG. 1 is a schematic diagram illustrating the MCVD method.

FIG. 2 shows the steps of preform manufacturing methods in Examples and Comparative examples.

FIG. 3 shows conditions in the respective steps of preform manufacturing methods in Examples and Comparative examples.

FIG. 4 is a graph showing the relationship between Cl-doping concentration and attenuation in 1200 nm wavelength band.

FIG. 5 is a graph showing the relationship between the thickness of P-doped glass layer and Cl-doping concentration at P step.

FIG. 6 is a graph showing the relationship between the heating temperature and Cl-doping concentration at Cl₂ treatment step.

FIG. 7 is a graph showing the relationship between the Cl-doping concentration and the ratio of the Cl₂ gas flow rate to the flow rate of the total gas introduced into the silica glass pipe at the Cl₂ treatment step.

FIG. 8 is a schematic diagram of an optical fiber amplifier relating to the present embodiment.

### DETAILED DESCRIPTION OF THE INVENTION

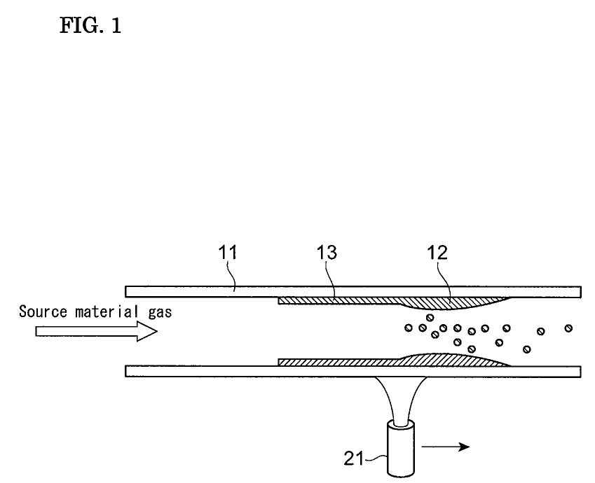

FIG. 1 is a schematic diagram illustrating the MCVD method. In the MCVD method, a silica glass pipe 11 is heated with a burner 21 by traversing the burner 21 from the one end to the other end of the of silica glass pipe 11 while a raw material gas is introduced inside the silica glass pipe 11 from the one end. The silica glass pipe 11 may be doped with fluorine. Fine glass particles are generated from the raw material gas by heating, and the fine glass particles are deposited on the inner wall of the silica glass pipe 11 so as to make a glass particle deposited layer 12. The glass particle deposited layer 12 is further heated by the traverse of the burner 21 so as to be dehydrated and sintered to become a consolidated glass layer 13. The raw material gas introduced inside the silica glass pipe 11 includes, for example, any of SiCl₄ gas, Er(C₁₁H₁₉O₂)₃ gas, AlCl₃ gas, POCl₃ gas, He gas, O₂ gas, and Cl₂ gas as needed.

Hereinafter, the preform manufacturing methods of Examples and Comparative examples will be described. In Examples and Comparative examples, preforms are prepared by using some of the following steps in combination: “P step” of depositing P₂O₅-containing SiO₂ fine glass particles on the inner wall of a silica glass pipe 11 (the first step); “Cl₂ treatment step” of introducing a Cl₂-containing gas into the silica glass pipe and heating the silica glass pipe to dehydrate the P₂O₅-containing glass (the second step); “EPA step” of depositing SiO₂ fine glass particles, which contain erbium, Al₂O₃ and P₂O₅, on the inner wall of the silica glass pipe 11; and “EA step” of depositing SiO₂ fine glass particles, which contain erbium and Al₂O₃, on the inner wall of the silica glass pipe 11 (the third step: glass which does not include P₂O₅ is deposited on the inner wall of the silica glass pipe).

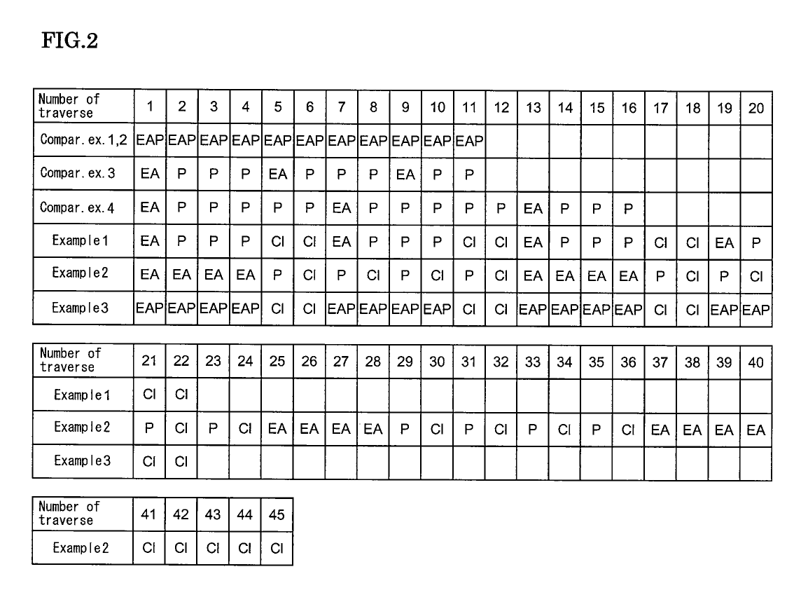

FIG. 2 shows the steps of preform manufacturing methods in Examples and Comparative examples. In Comparative examples 1 and 2, the traverses of the burner 21 from the first to 11th are all EAP steps. In Comparative example 3, the first, fifth, and ninth traverses of the burner 21 are respectively EA steps, and the 2nd to 4th, 6th to 8th, 10th, and 11th traverses are respectively P steps. In Comparative example 4, the 1st, 7th, and 13th traverses are EA steps, and the 2nd to 6th, 8th to 12th, and 14th to 16th traverses are respectively P steps.

In Example 1, the 1st, 7th, 13th, and 19th traverses are respectively EA steps, the 2nd to 4th, 8th to 10th, 14th to 16th and 20th traverses are respectively P steps, and the 5th, 6th, 11th, 12th, 17th, 18th, 21st, and 22nd traverses are respectively Cl₂ treatment steps. In Example 2, the 1st to 4th, 13th to 16th, 25th to 28th, and 37th to 40th traverses are respectively EA steps; the 5th, 7th, 9th, 11th, 17th, 19th, 21st, 23rd, 29th, 31st, 33rd, and 35th traverses are respectively P steps; and the 6th, 8th, 10th, 12th, 18th, 20th, 22nd, 24th, 30th, 34th, 36th, and 41st to 45th traverses are respectively Cl₂ treatment steps. In Example 3, the 1st to 4th, 7th to 10th, 13th to 16th, 19th, and 20th traverses are respectively EA steps; and the 5th, 6th, 11th, 12th, 17th, 18th, 21st, and 22nd traverses are respectively Cl₂ treatment steps.

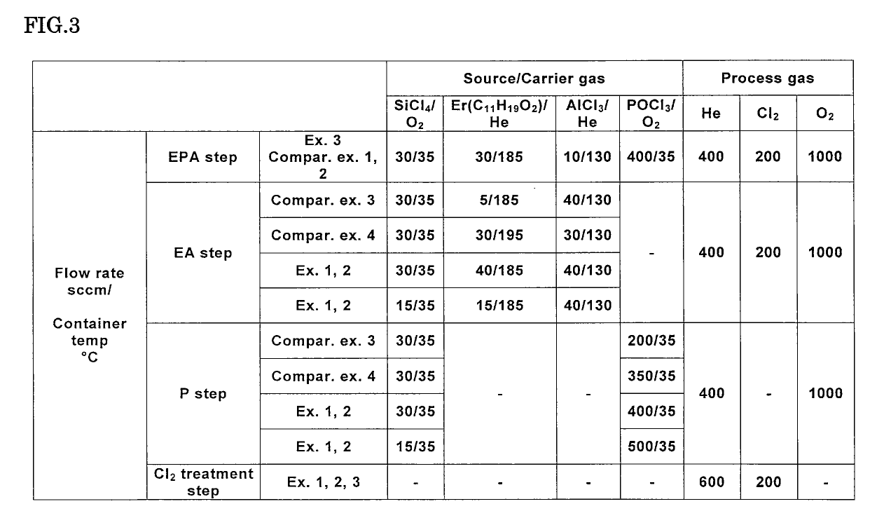

FIG. 3 shows conditions in the respective steps of preform manufacturing methods in Examples and Comparative examples. In the respective steps of Examples 1 to 3 and Comparative examples 1 to 4, an oxyhydrogen burner was used as the burner 21 and the moving speed of the burner 21 was set to 120 mm/min. The heating temperature of the silica glass pipe 11 by the burner 21 at the EAP step was 1500° C. in Comparative example 1, 1200° C. in Comparative example 2, and 1200° C. in Example 3. The heating temperature of the silica glass pipe 11 by the burner 21 was 1850° C. at the EA steps, 1100° C. at the P steps, and 1800° C. at the Cl₂ treatment steps, respectively.

The following Table shows the concentrations of phosphorus, aluminum, erbium, and chlorine of the core region, and the attenuation at the 1200 nm wavelength band with respect to the of preforms prepared by the preform manufacturing methods in the Examples and Comparative examples, respectively.

TABLE

| | Concentration wt % | | | | Attenuation |
|---|---|---|---|---|---|
| | P | Al | Er | Cl | dB/km |
| Comparative example 1 | 4.5 | 1.0 | 30 | 0.012 | 500 |
| Comparative example 2 | 4.3 | 1.1 | 100 | 0.012 | 500 |
| Comparative example 3 | 3.0 | 0.9 | 500 | 0.012 | 500 |
| Comparative example 4 | 5.8 | 0.9 | 2000 | 0.012 | 500 |
| Example 1 | 4.8 | 0.6 | 700 | 0.025 | 40 |
| Example 2 | 4.5 | 1.1 | 1400 | 0.032 | 8.1 |
| Example 3 | 4.2 | 1.1 | 80 | 0.024 | 50 |

In Examples 1 to 3, in which the Cl₂ treatment step is inserted, the attenuation in the 1200 nm wavelength band is reduced as compared with Comparative examples 1 to 4. Thus, according to the present invention, the preform for making a low-loss optical fiber doped with a rare earth and phosphorus can efficiently be manufactured. In addition, in Examples 1 and 2, each step can be processed at high temperature, allowing the stabilization of the heat source, and hence the fluctuation in the dopant concentration and the deposition rate can be restrained, which enables easy manufacture of a preform that is uniform in the longitudinal direction.

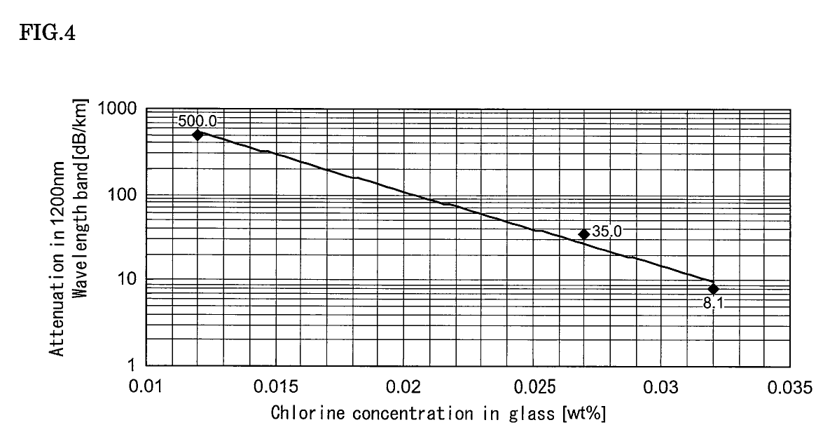

FIG. 4 is a graph showing the relationship between Cl-doping concentration and attenuation in the 1200 nm wavelength band. The higher the Cl-doping concentration, the lower the attenuation of the optical fiber in the 1200 nm wavelength band. From the viewpoint of practical use, the attenuation of the optical fiber is preferably 20 dB/km or less in the 1200 nm wavelength band. Therefore, as can be seen from FIG. 4, it is preferable that the Cl concentration be equal to or more than 0.03 wt %.

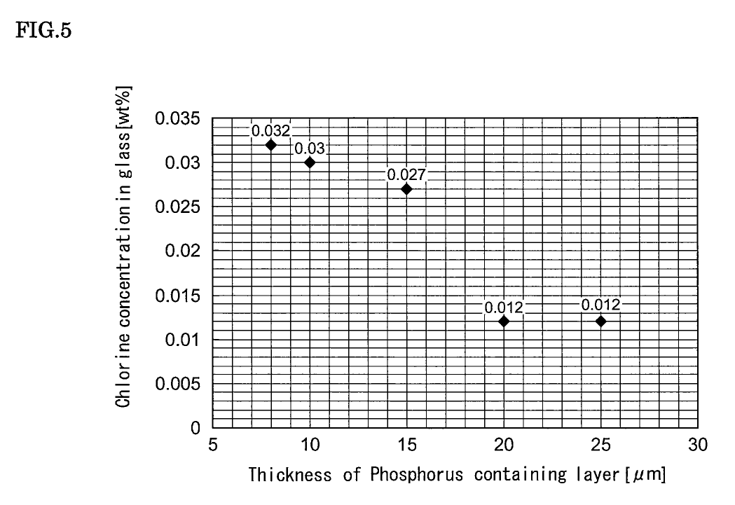

FIG. 5 is a graph showing the relationship between the thickness of P-doped glass layer and Cl-doping concentration at P step. The thicker the thickness of the P-doped glass layer at the P step, the lower the doping concentration of chlorine that can be added to the P-doped glass layer. In order to make the Cl-doping concentration equal to or more than 0.03 wt %, it is necessary that the film thickness of P₂O₅-containing glass deposited on the inner wall of the silica glass pipe at P step be 10 μm or less.

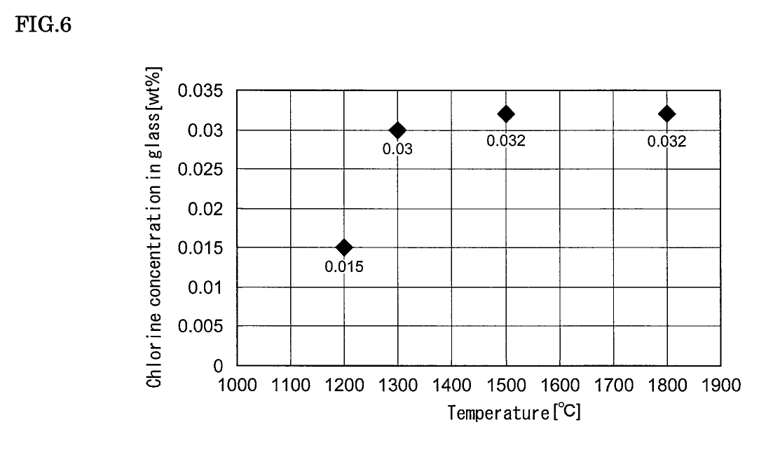

FIG. 6 is a graph showing the relationship between the heating temperature and Cl-doping concentration at Cl₂ treatment step. In such Cl₂ treatment step, the film thickness of the P-doped glass layer is 10 μm, the Cl-gas flow rate is 200 cc/min, the flow rate of He gas is 600 cc/min, and the ratio of the flow rate of Cl₂ gas to the total gas flow rate is 0.25. The higher the heating temperature at the Cl₂ treatment step, the higher the Cl-doping concentration. To make the Cl-doping concentration equal to or more than 0.03 wt %, it is necessary to heat the silica glass pipe to 1300° C. or more at the Cl₂ treatment step.

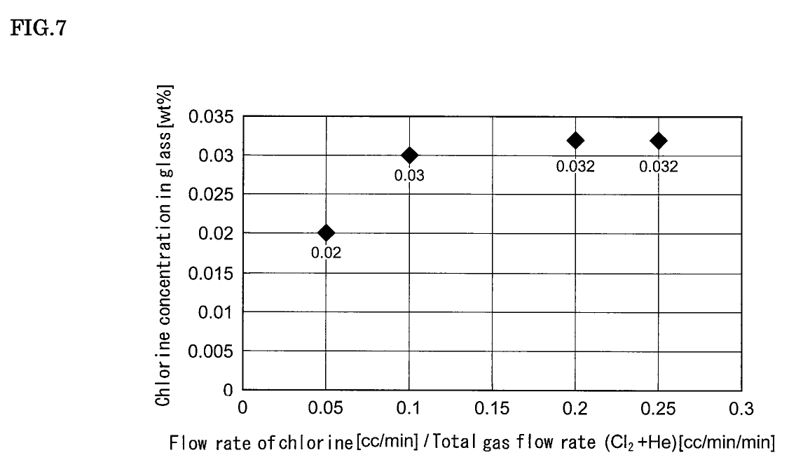

FIG. 7 is a graph showing the relationship between the Cl-doping concentration and the ratio of the Cl₂ gas flow rate to the flow rate of the total gas introduced into the silica glass pipe at the Cl₂ treatment step. In such Cl₂ treatment step, the heating temperature is 1800° C. and the film thickness of the P-doped glass layer is 10 μm. The larger the ratio of the Cl₂ gas flow rate to the total gas flow rate, the higher the Cl-doping concentration. To achieve a Cl-doping concentration of 0.03 wt % or more, the flow rate of the Cl₂ gas introduced into the silica glass pipe in the second step must be equal to or more than 1/10 of the total gas flow rate.

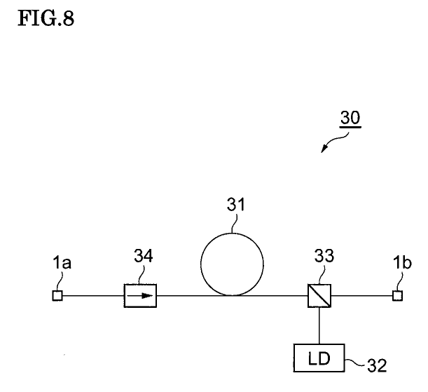

FIG. 8 is a schematic diagram of an optical fiber amplifier 30 relating to the present embodiment. The optical fiber amplifier 30 shown in FIG. 8 comprises a rare-earth-doped optical fiber 31, a pump light source 32, a multiplexer/demultiplexer 33, and an optical isolator 34.

The rare-earth-doped optical fiber 31 has a core region and a cladding region. The core region has a P concentration of 3 wt % or more, Al concentration of 0.3 wt % or more, rare-earth concentration of 500 wtppm or more, and Cl concentration of 0.03 wt % or more. The cladding region, which surrounds the core region, has refractive index that is lower than the refractive index of the core region. The attenuation of the rare-earth-doped optical fiber 31 at the 1200 nm wavelength is 15 dB/km or less. The rare-earth-doped optical fiber 31 can be obtained by drawing a preform manufactured by the above-mentioned preform manufacturing method. The rare-earth element added to the core region is preferably erbium, and the cladding region is preferably doped with fluorine. Preferably, the rare-earth-doped optical fiber 31 is such that gain is obtained in a wavelength range including a wavelength range of 1565 nm to 1625 nm.

The pump light source 32 outputs pump light having a wavelength capable of exciting the rare-earth element added to the core region of the rare-earth-doped optical fiber 31. The multiplexer/demultiplexer 33 supplies the pump light output from the pump light source 32 to the rare-earth-doped optical fiber 31, and also inputs the signal light output from the rare-earth-doped optical fiber 31 so as to output it from the emitting end 1b. The optical isolator 34, which is provided between the incident end la and the rare-earth-doped optical fiber 31, allows light to pass in the forward direction, and does not allow the light to pass in the opposite direction.

In the optical fiber amplifier 31, the pump light output from the pump light source 32 is supplied to the rare-earth-doped optical fiber 31 via the multiplexer/demultiplexer 33. The signal light input to the incident end 1a is put into the rare-earth-doped optical fiber 31 via the optical isolator 34, and is optically amplified in the rare-earth-doped optical fiber 31. The signal light thus optically amplified is output from the emitting end 1b to the outside via the multiplexer/demultiplexer 33. The optical fiber amplifier 31 can optically amplify signal light with a broad bandwidth.

While this invention has been described in connection with what is presently considered to be the most practical and preferred embodiments, the invention is not limited to the disclosed embodiments, but on the contrary, is intended to cover various modifications and equivalent arrangements included within the spirit and scope of the appended claims.

The entire disclosure of Japanese Patent Application No. 2008-006074 filed on Jan. 15, 2008 including specification, claims, drawings, and summary are incorporated herein by reference in its entirety.

What is claimed is:

1. A method of producing a preform having a rare-earth doped core region, the method comprising a first step and a second step,
the first step being such that P₂O₅-containing glass is deposited on the inside of a silica glass pipe while a heat source is traversed one or more times along the silica glass pipe, and
the second step being such that while the heat source is traversed one or more times along the silica glass pipe, a Cl₂-containing gas is introduced inside the silica glass pipe and the P₂O₅-containing glass is dehydrated by heating the silica glass pipe,
wherein the first step and the second step are alternately repeated.

2. A method of producing a preform according to claim 1,
wherein a third step is further provided such that while the heat source traverses one or plurality of times along the silica glass pipe, glass which does not contain P₂O₅ is deposited on the inside of the silica glass pipe, so that the first step, the second step, and the third step are repeatedly performed in this order.

3. A method of producing a preform according to claim 2,
wherein the glass which does not include P₂O₅ contains a rare-earth element.

4. A method of producing a preform according to claim 1,
wherein the layer thickness of the P₂O₅-containing glass is 10 μm or less.

5. A method of producing a preform according to claim 1,
wherein the silica glass pipe is heated to 1300° C. or more in the second step.

6. A method of producing a preform according to claim 1,
wherein the flow rate of the Cl₂ gas is equal to or more than 1/10 of the total gas flow rate in the second step.

7. A rare-earth-doped optical fiber having a attenuation of 15 dB/km or less at a wavelength of 1200 nm, the optical fiber comprising a core region and a cladding region enclosing the core region,
wherein the core region includes phosphorus of 3 wt % or more, aluminum of 0.3 wt % or more, a rare-earth element of 500 wtppm or more, and chlorine of 0.03 wt % or more, and the cladding region has a refractive index that is lower than the refractive index of the core region.

8. A rare-earth-doped optical fiber according to claim 7,
wherein the cladding region contains fluorine.

9. An optical fiber amplifier comprising
a rare-earth-doped optical fiber according to claim 7 or 8,
a pump light source, and
a multiplexer/demultiplexer,
wherein the pump light source outputs pump light having a wavelength capable of exciting the rare-earth element added to the core region of the rare-earth-doped optical fiber, and the multiplexer/demultiplexer supplies the pump light output from the pump light source to the rare-earth-doped optical fiber.

10. An optical fiber amplifier according to claim 9, wherein gain is obtained in a wavelength range including a wavelength range of 1565 nm to 1625 nm.
